(19) United States
(12) Patent Application Publication
(10) Pub. No.: US 2026/0082418 A1
(43) Pub. Date: Mar. 19, 2026

(54) Hybrid Power Control for Near-Field Communication Systems

(71) Applicant: ZEBRA TECHNOLOGIES CORPORATION, Lincolnshire, IL (US)

(72) Inventors: Marek Trusinski, Kings Park, NY (US); Arun Gupta, Bangalore (IN); Praveen Voonna, Visakhapatnam (IN)

(21) Appl. No.: 18/890,671

(22) Filed: Sep. 19, 2024

(51) Int. Cl. H04W 74/06; H04W 24/10; H04W 52/36; H04W 74/0816

(52) U.S. Cl. CPC H04W 74/06; H04W 24/10; H04W 52/367; H04W 74/0816

(57) ABSTRACT

A method includes: controlling a short-range wireless communication assembly of a computing device during a sequence of time periods, each time period having a polling sub-period, by: during a first time period in the sequence: transmitting, from the short-range wireless communication assembly, a first polling signal according to a first power level during a polling sub-period of the first time period; and during a second time period of the sequence: transmitting, from the short-range wireless communication assembly, a second polling signal according to a second power level during a polling sub-period of the second time period.

### BACKGROUND

In some computing devices, a near-field communication (NFC) antenna may be placed in physical proximity to a component sensitive to electromagnetic fields, such as a display panel. Operation of the NFC antenna in such devices can affect the performance of the display, e.g., leading to visual artifacts.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram of a computing device.

FIG. 2 is a diagram of a near-field communication (NFC) control cycle.

FIG. 3 is a flowchart of a method for hybrid NFC power control in the device of FIG. 1.

FIG. 4 is a diagram illustrating example configuration data employed in the method of FIG. 3.

FIG. 5 is a diagram illustrating an example performance of the method of FIG. 3.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a method including: controlling a short-range wireless communication assembly of a computing device during a sequence of time periods, each time period having a polling sub-period, by: during a first time period in the sequence: transmitting, from the short-range wireless communication assembly, a first polling signal according to a first power level during a polling sub-period of the first time period; and during a second time period of the sequence: transmitting, from the short-range wireless communication assembly, a second polling signal according to a second power level during a polling sub-period of the second time period.

Additional examples disclosed herein are directed to a computing device, comprising: a short-range wireless communication assembly including an antenna; a processor configured to control the short-range wireless communication assembly during a sequence of time periods, each time period having a polling sub-period, by: during a first time period in the sequence: transmitting, from the short-range wireless communication assembly, a first polling signal according to a first power level during the polling sub-period of the first time period; and in a second time period of the sequence: transmitting, from the short-range wireless communication assembly, a second polling signal according to a second power level during the polling sub-period of the second time period.

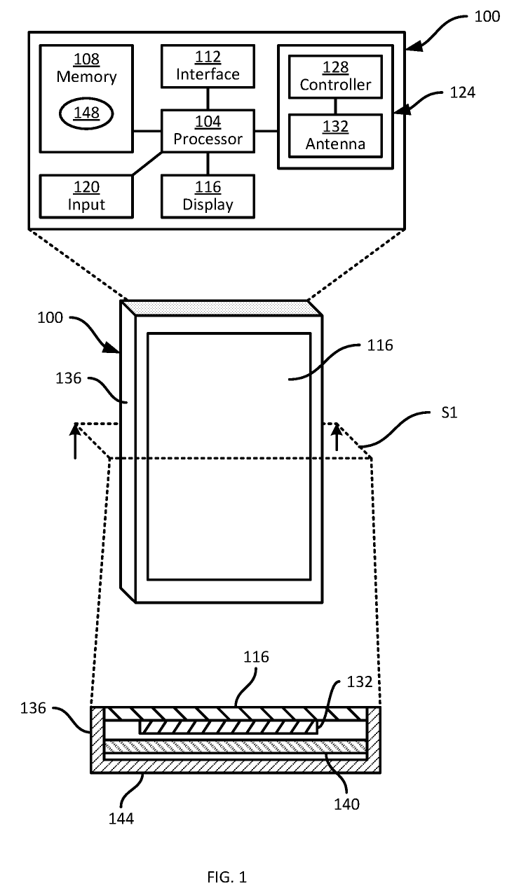

FIG. 1 illustrates a computing device 100, such as a mobile computer, smart phone, or the like. The device 100 can be implemented in a wide variety of other form factors, including a tablet computer, a laptop computer, a barcode scanner, an RFID reader, and the like.

Certain internal components of the device 100 are illustrated in FIG. 1. The device 100 includes a processor 104, such as a central processing unit (CPU), graphics processing unit (GPU) or the like, connected with a non-transitory computer readable medium such as a memory 108. The processor 104 and the memory 108 are implemented as one or more integrated circuits (ICs). The device 100 also includes a communications interface 112 enabling communication between the device 100 and other computing devices, via suitable wired and/or wireless links, including any suitable combination of local-area networks, wide-area networks, and peer-to-peer links.

The device 100 further includes a display 116, such as an organic light-emitting diode (OLED)-based display panel or other suitable panel. The display 116 is controllable by the processor 104 to present a wide variety of information, e.g., for viewing by an operator of the device 100. The device 100 can also include other output devices (e.g., devices configured to generate output perceptible by the operator of the device 100) in some examples, such as a speaker, a motor for haptic output, and the like. The device 100 further includes an input device 120 configured to receive input, e.g., from the operator of the device 100. The input device 120 can include any one of, or any combination of, a keypad, a touchscreen (e.g., integrated with the display 116), a microphone, or the like.

The device 100 also includes a short-range wireless communication assembly 124, such as a near-field communication (NFC) assembly, or the like. The short-range wireless communication assembly 124 is configured to facilitate short-range (e.g., over distances of less than about 10 cm) exchange of information between the device 100 and other computing devices such as payment terminals, other mobile computers, or the like. The assembly 124 can also enable the device 100 to read data from articles such as smart payment cards. The assembly 124 includes a controller 128, and an antenna 132. The controller 128 can be configured to transmit and receive data, via the antenna 132, at a frequency of about 13.5 MHz. Data received via the antenna 132 can be provided to the processor 104 by the controller 128, and data can be received at the controller 128 from the processor 104, for transmission via the antenna 132. The controller 128 can be implemented as a field-programmable gate array (FPGA), and application-specific integrated circuit (ASIC), or the like. In some examples, the controller 128 can be implemented by the processor 104 (e.g., as a dedicated hardware portion of the processor 104, or in software).

The components of the device 100 can be supported by a housing 136. For example, as shown in the cross section S1 (simplified for illustrative purposes), the housing 136 can support the display 116 (and the input 120, when the input 120 includes a touch screen), and an interior of the device enclosed by the housing 136 and the display 116 can contain the other components of the device 100. For example, the device 100 can include a main board such as a printed circuit board (PCB), or a plurality of PCBs, carrying the processor 104, memory 108, and communications interface 112. The board 140 can also carry the controller 128 in some examples.

The antenna 132, in this example, is disposed “behind” the display 116, e.g., between the display 116 and the main board 140. The antenna 132 can be configured to radiate through the display 116, rather than away from the display 116 through the back 144 of the housing 136. As will be understood by those skilled in the art, the display 116 can include a plurality of layers of conductive material. When the input 120 includes a touch screen, the touch screen can also be implemented as one or more additional layers of conductive material between the antenna 132 and the front of the device 100. The display 116 (and, in some examples, touch screen) can therefore attenuate radiation emitted by the antenna 132. Attenuation of radiation from the antenna 132 can negatively impact performance of the assembly 124, e.g., by reducing the effective range of the assembly 124. An approach to mitigating such performance impacts is to increase the transmission power applied at the antenna 132 (e.g., by the controller 128). However, due to the relatively low operating frequency of the antenna 132 (e.g., compared to the near-GHz or multi-GHz operating frequencies of cellular or wireless local area network antennas employed by the interface 112), transmissions from the antenna 132 may interfere with the display 116, e.g., causing flickering, ghosting, or other visual artifacts.

In other words, improving the performance of the antenna 132 may negatively affect performance of the display 116, and avoiding such negative effects may instead impact the performance of the antenna 132. The device 100 is therefore configured, as discussed below, to implement a hybrid power control mechanism for the antenna 132. The processor 104 and/or the controller 128 are configured to apply distinct power levels to the antenna 132 at particular times. The control mechanism discussed herein mitigates the negative impacts of NFC operation on the display 116 for at least some periods of time by operating the antenna 132 at reduced power. For other periods of time, the device 100 operates the antenna 132 at increased power, e.g., for time periods that are sufficiently short, and/or are sufficiently spaced apart, that visual artifacts in the display 116 caused by the antenna 132 are either avoided or rendered less perceptible.

The memory 108 stores a plurality of applications executable by the processor 104, including an NFC control application 148, whose execution by the processor 104 configures the processor 104 to perform various actions to effect hybrid power control for the assembly 124. In some examples, the functionality described below as being implemented by the application 148 can be implemented by the controller 128, instead of by the processor 104. For example, the application 148 can be implemented in firmware of the controller 128. In other examples, the functionality of the application 148 can be implemented in a distinct hardware element, separate from the processor 104 and the controller 128, such as another ASIC, FPGA, or the like.

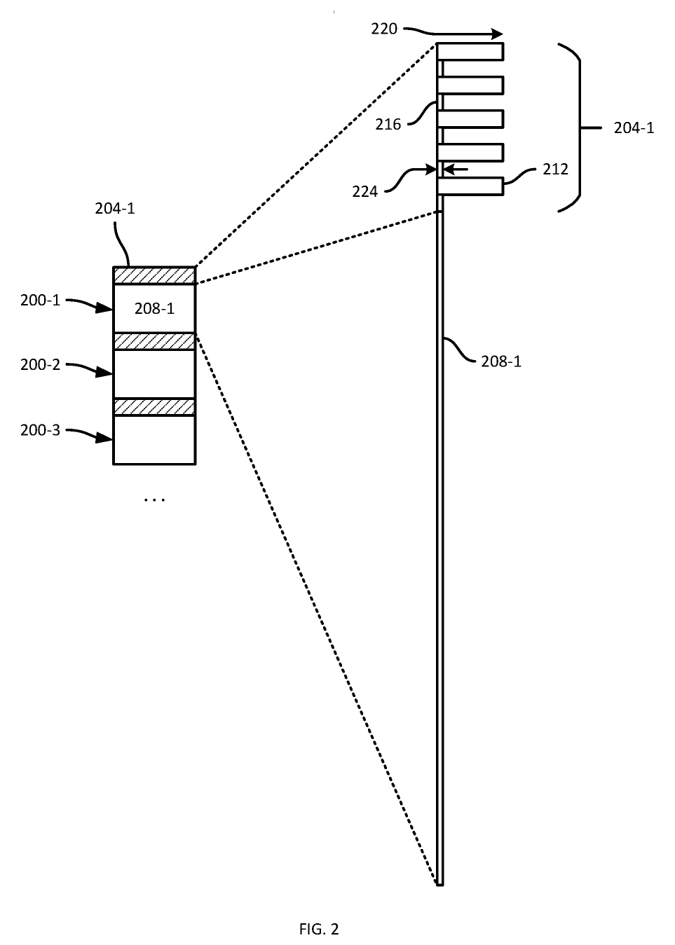

Before discussing the functionality implemented by the device 100, an example NFC control mechanism is shown in FIG. 2. NFC assemblies such as the assembly 124 can be configured, upon activation, to repeat a polling cycle, e.g., according to specifications established by the NFC Forum. The assembly 124 can be configured to transmit polling signals, and monitor for responses to polling signals and/or for polling signals from other devices, over the course of a time period 200, of which three examples 200-1, 200-2, and 200-3 are shown in FIG. 2. During each time period 200, the assembly 124 can repeat the same set of actions. In this example, the time period 200-1 is illustrated in detail on the right-hand side of FIG. 2. The time period 200-1 includes a polling portion 204-1, during which the assembly 124 is configured to transmit one or more polling signals via the antenna 132, and to monitor for responses to such polling signals, e.g., from payment cards or the like. The time period 200-1 also includes an emulation sub-period 208-1.

The polling portion 204-1 can be subdivided into a polling sub-period 212, and a listening sub-period 216. In this example, each time period 200 includes five polling sub-periods 212, and five listening sub-periods 216. Each pair of a polling sub-period 212 and a listening sub-period 216 can be configured to detect and/or receive data from nearby devices or articles implementing different NFC standards (e.g., NFC Type A, Type B, Type F or FeliCa at 424 kbit/s, Type F or FeliCa at 212 kbit/s, and the like). The detailed view on the right-hand side of FIG. 2 illustrates power levels applied to the antenna 132 by the controller 128 during each sub-period. That is, during the polling sub-periods 212, the controller 128 can apply a first power level 220, e.g., a default or maximum design power, to the antenna 132. During the listening sub-periods 216, the antenna 132 can be passive (that is, no power is applied to the antenna 132). The controller 128 can, in other words, apply an idle power level 224 to the antenna 132 during the listening sub-periods. The idle power level can be zero, in some examples, but need not be exactly zero.

During the emulation sub-period 208-1 of the time period 200-1, the assembly 124 can be configured to monitor or listen for external polling signals, e.g., from another device performing the polling portion 204-1. In other words, during the polling sub-periods 212 and listening sub-periods 216, the device 100 seeks nearby NFC devices such as payment cards or the like. During the emulation sub-period 208-1, the device 100 emulates a payment card or the like, and awaits a polling signal from a nearby reader device, if any is present. The idle power level 224 is therefore also used during the emulation sub-period 208-1.

The length of time occupied by the polling portion 204-1 and the emulation sub-period 208-1 can be defined by any suitable standard. In this example, the total length of the time period 200-1 can be about 600 ms, with the polling portion occupying about 150 ms and the emulation sub-period 208-1 occupying about 450 ms. Each pair of a polling sub-period 212 and a listening sub-period can occupy about 30 ms. A wide variety of other configurations can also be applied, however.

When the time period 200-1 is complete, the assembly 124 can be configured to repeat the configuration shown above during the time periods 200-2, 200-3, and so, until the assembly 124 is deactivated (e.g., put in a sleep state, disabled, or the like). The power level applied to the antenna 132 at each polling sub-period 212, in this configuration, is substantially equal, and may be equivalent to a default or maximum design power for the assembly 124. As discussed below, in other examples, the device 100 is configured to use distinct power levels during different time periods to mitigate negative performance impacts on the display 116 and/or the assembly 124.

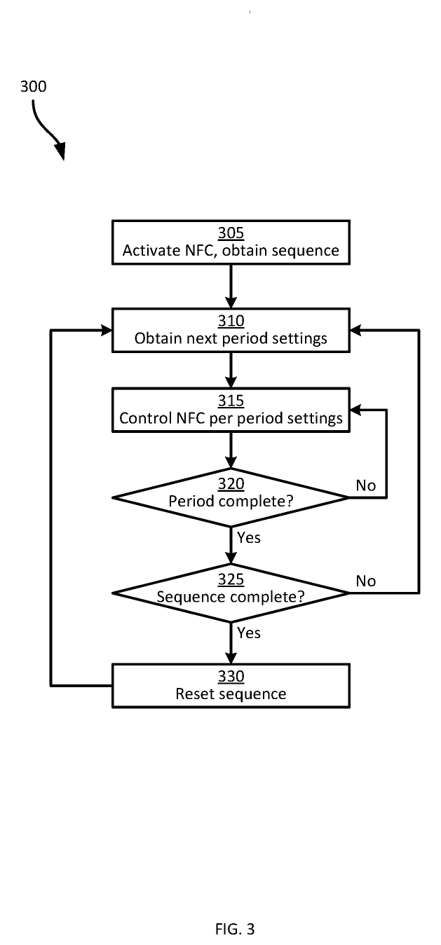

Turning to FIG. 3, a method 300 of hybrid power control for near-field communication is shown. The method 300 will be described in conjunction with its performance in the device 100, and in particular by the processor 104, via execution of the application 148.

At block 305, the device 100 is configured to activate the assembly 124. Block 305 can be performed, for example, when the device 100 is powered on, or when an application or other function of the device 100 calls for enabling the assembly 124 (e.g., to initiate a payment transaction or the like). When the assembly 124 is activated, the device 100 (e.g., the processor 104 as configured via execution of the application 148) can be configured to obtain an NFC control sequence that defines a plurality of time periods each having at least a polling sub-period.

While the control mechanism shown in FIG. 2 uses the same configuration for each successive time period 200 (e.g., in that the assembly 124 uses the same power level 220 for the polling signals sent during the polling sub-periods 212, in each time period 200), the control sequence obtained at block 305 defines distinct time period configurations, as well as a pattern according to which the time period configurations are implemented by the assembly 124. The control sequence can be obtained at block 305 by retrieval from the memory 108, for example. In other examples, the control sequence can be encoded in the application 148, or stored in a memory element of the controller 128. Storage of the control sequence in the memory 108, e.g., in the form of a configuration file, can facilitate the deployment of varying short-range wireless communication assembly behavior across distinct devices (e.g., with different form factors, display hardware, and the like), without necessarily requiring modifications to the assembly 124. For example, a plurality of devices 100, e.g., with differing housings 136, displays 116, and the like, can be configured to control the assembly 124 according to model-specific configuration files, even if those devices use the same type of assembly 124.

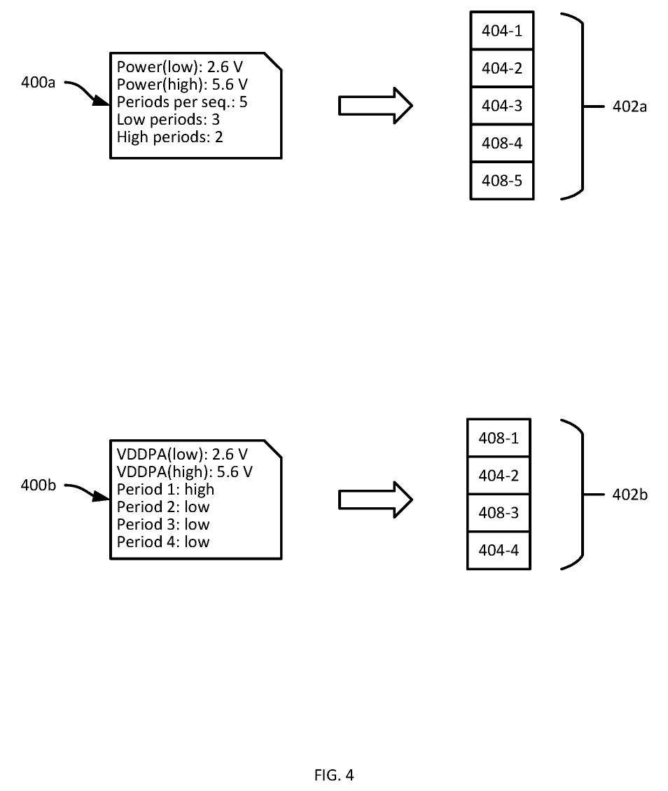

FIG. 4 illustrates two example configuration data 400a and 400b (referred to generically as configuration data 400) that can be obtained at block 305. Various other forms of configuration data will also occur to those skilled in the art. The configuration data 400a specifies a first power level, and a second power level. In this example, the first power level is a “low” power level, selected to mitigate or avoid interfering with the display 116 when the antenna 132 is transmitting. The second power level is a “high” power level, which may correspond to a default power level (e.g., a maximum power level the controller 128 is designed to apply to the antenna 132). The power levels are expressed as voltages applied to the antenna 132 in this example, but other forms of power level specification can also be used in other examples. In this example, the low power level configures the controller 128 to apply 2.6 V to the antenna 132, and the high power level configures the controller 128 to apply 5.6 V to the antenna 132. The specific voltages defined in the configuration data 400a can also vary based on the specific implementation.

The configuration data 400a further defines a number of time periods per control sequence, and an association between each time period and one of the first power level and the second power level. Each time period corresponds to one cycle of a polling portion (that is, at least one polling sub-period and at least one listening sub-period) and an emulation sub-period. In this example, the configuration data 400a includes a count “5” indicating the number of time periods in the control sequence. In other examples, as described below in conjunction with the configuration data 400b, such a count may be omitted. The sequence defined by the configuration data 400a, therefore, includes five time periods, each with a length implemented by the assembly 124 according to a suitable standard (e.g., 600 ms, as mentioned earlier). In other examples, the duration of the time periods can also be specified in the configuration data 400a.

The configuration data 400a further indicates which time periods in the sequence correspond to the lower power level, and which time periods in the sequence correspond to the higher power level. In other words, the configuration data 400a specifies a pattern of which power level is to be applied to the antenna 132 to generate polling signals during which time periods. In this example, the configuration data 400a a control sequence 402a with a length of five time periods, in which the first three time periods 404-1, 404-2, and 404-3 are low-power periods (that is, periods during which the first, or “low”, power level is used), and the remaining two time periods 408-4 and 408-5 are high-power periods (that is, periods during which the second, or “high”, power level is used). The control sequence 402a, in other words, includes two types of time periods, with one type labelled 404 and the other type labelled 408. The numbered suffixes indicate the position of each period in time. That is, the time period 404-1 may have a duration of 600 ms, and the time period 404-2 may therefore begin at the end of the time period 404-2 and extend a further 600 ms (ending 1.2 s after the control sequence as a whole begins).

The configuration data 400b also specifies low and high power values, as described above, and defines a control sequence 402b by specifying a power level for each time period. In this example, the configuration data 400b indicates that the first and third time periods 408-1 and 408-3 are associated with the high power level, and that the second and fourth time periods 404-2 and 404-4 are associated with the low power level. The control sequence 402b thus has a length of four time periods (e.g., a total length of 2.4 s in this example).

As will be understood by those skilled in the art, a wide variety of configuration data 400 can be deployed to any given device 100, e.g., specifying control sequences with fewer than four time periods, or more than five time periods. Any of a wide variety of patterns of low-power and high-power time periods can also be specified.

Returning to FIG. 3, at block 310, the device 100 is configured to obtain configuration settings for the next time period defined by the sequence obtained at block 305. For example, the device 100 can be configured to obtain the power level associated with the first time period 404-1 according to the configuration data 400b (e.g., the high power level). In some examples, the processor 104 can obtain a power level at block 310, and the controller 128 can obtain a time period duration, polling sub-period configuration, and the like (e.g., which can be encoded or otherwise stored at the controller 128).

At block 315, the device 100 is configured to control the assembly 124 according to the period settings obtained at block 310. For example, the processor 104 can be configured to send a command to the controller 128, e.g., according to the NFC controller interface (NCI) standard, including the power level for the current time period as defined in the configuration data 400b. The controller 128 can be configured to apply that power level to the antenna 132 according to a predefined sub-period structure.

Controlling the assembly 124 according to the period settings from block 310 includes transmitting polling signals during one or more polling sub-periods, each followed by a corresponding listening sub-period. Following the polling and listening sub-periods, controlling the assembly 124 can include an emulation sub-period where the controller 128 monitors for external polling signals detected at the antenna 132.

At block 320, the device 100 is configured to determine whether the current time period is complete, e.g., whether one cycle of polling sub-periods, listening sub-periods, and an emulation sub-period, is complete. When the determination at block 320 is negative, the device 100 continues to transmit polling signals, listen for responses to polling signals, or listen for external polling signals. When the determination at block 320 is affirmative, the device 100 proceeds to block 325 and determines whether the control sequence obtained at block 305 is complete. For example, when the configuration data 400b was retrieved at block 305, at block 325 the device 100 is configured to determine whether all four time periods of the sequence 402b have been performed via successive performances of block 315. The processor 104 and/or the controller 128 can, for example, maintain a counter indicating which time period in the sequence 402b is the current time period.

When the determination at block 325 is negative, the device 100 returns to block 310, and obtains settings (e.g., a power level) for the next time period in the sequence (e.g., for the time period 404-2 in the sequence 402b). The device 100 is then configured to repeat the subsequent blocks of the method 300 for the current time period. For example, the processor 104 can send a further NCI command to the controller 128 with the power level for the current time period.

When the determination at block 325 is affirmative, the device 100 can be configured to reset the sequence at block 330, and return to block 310. That is, until the assembly 124 is disabled (e.g., automatically placed in a sleep state when no activity is detected for a period of time, explicitly disabled by another application, or the like), the assembly 124 can be configured to repeat the control sequence from block 305.

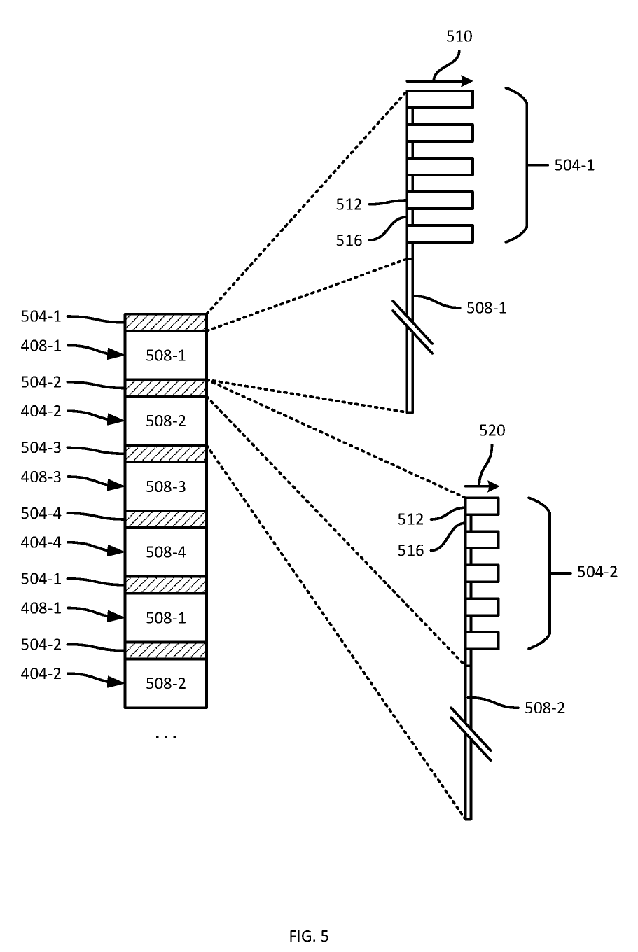

Turning to FIG. 5, an example performance of the method 300 is illustrated, based on the control sequence 402b. At block 310, the device 100 selects the settings of the first time period 408-1. The first time period 408-1 includes a polling portion 504-1 followed by an emulation sub-period 508-1. At block 315 during one or more polling sub-periods 512 (five, in this example) of the polling portion 504-1, the controller 128 applies a first power level 510 to the antenna 132 to transmit respective polling signals. The controller 128 then monitors for responses to the polling signals during respective listening sub-periods 516. After the final listening sub-period 516, the controller 128 monitors for external polling signals during the emulation sub-period 508-1. When the emulation sub-period 508-1 ends, the determination at block 320 is affirmative, and the device 100 returns to block 310 to obtain settings for the next time period 404-2, which includes a polling portion 504-2 also including a set of polling sub-periods 512 and listening sub-periods 516. The time period 404-2 also includes an emulation sub-period 508-2.

As shown in FIG. 5, at block 315 the controller 128 applies a second power level 520, smaller than the first power level 510, to the antenna 132 during the polling sub-periods 512. As will be understood by those skilled in the art, following the time period 404-2 and another negative determination at block 325, the device 100 is configured to control the assembly 124 according to the settings of the time periods 408-3 and 404-4 (including respective polling portions 504-3 and 504-4, and respective emulation sub-periods 508-3 and 508-4) as specified in the configuration data 400b. The polling signals transmitted in the polling portion 508-3 use the high power setting, while the polling signals transmitted in the polling portion 508-4 use the low power setting. As also seen in FIG. 5, when the sequence 402b is complete, upon completion of the time period 404-4, at block 330 the device 100 can initiate a repetition of the sequence 402b, beginning with another instance of the time period 408-1.

As will be apparent to those skilled in the art in light of the discussion above, the control sequence 402b (or any other suitable control sequence, such as the sequence 402a) implemented by the device 100 may improve the overall performance of the device 100 by reducing the amount of time that the assembly 124 may cause visual artifacts at the display 116, because the low-power time periods 404 mitigate or avoid such artifacts. Although the high-power time periods 408 may result in visual artifacts, the limited duration of such effects may render them imperceptible to an operator of the device 100. Further, although the low-power time periods 404 may reduce the performance of the assembly 124, e.g., by reducing the effective NFC range of the assembly 124, the high-power periods 408 permit the device 100 to still interact with devices beyond such lowered effective range. Thus, the impact on NFC performance is also limited. Still further, the use of hybrid power levels during the control sequences discussed above may reduce power consumption at the assembly 124.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms "comprises," "comprising," “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises …a”, “has …a”, “includes …a”, “contains …a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method, comprising:
controlling a short-range wireless communication assembly of a computing device during a sequence of time periods, each time period having a polling sub-period, by:
during a first time period in the sequence:
transmitting, from the short-range wireless communication assembly, a first polling signal according to a first power level during a polling sub-period of the first time period; and
during a second time period of the sequence:
transmitting, from the short-range wireless communication assembly, a second polling signal according to a second power level during a polling sub-period of the second time period.

2. The method of claim 1, wherein each of the time periods in the sequence further includes a listening sub-period following the polling sub-period; the method further comprising:
monitoring for a first response to the first polling signal during the listening sub-period of the first time period, and
monitoring for a second response to the second polling signal during the listening sub-period of the second time period.

3. The method of claim 1, wherein each of the time periods in the sequence further includes an emulation sub-period; the method further comprising:
monitoring for a first external polling signal in the emulation sub-period of the first time period; and
monitoring for a second external polling signal in the emulation sub-period of the second time period.

4. The method of claim 1, wherein one of the first power level and the second power level is smaller than the other of the first power level and the second power level.

5. The method of claim 1, wherein the one of the first power level and the second power level is selected to mitigate visual artifacts at a display of the computing device during transmission of at least one of the first polling signal or the second polling signal.

6. The method of claim 1, wherein the first time period and the second time period of the sequence have equal lengths.

7. The method of claim 1, further comprising, during a third time period of the sequence:
transmitting, from the short-range wireless communication assembly, a third polling signal according to one of the first power level and the second power level, during the polling sub-period of the third time period.

8. The method of claim 1, further comprising, prior to controlling the short-range wireless communication assembly:
obtaining configuration data including the first power level and the second power level.

9. The method of claim 8, wherein the configuration data further includes:
the sequence of time periods, and
for each of the time periods, an association between the time period and one of the first power level and the second power level.

10. The method of claim 1, wherein the short-range wireless communication assembly is a near-field communication (NFC) assembly.

11. A computing device, comprising:
a short-range wireless communication assembly including an antenna;
a processor configured to control the short-range wireless communication assembly during a sequence of time periods, each time period having a polling sub-period, by:
during a first time period in the sequence: transmitting, from the short-range wireless communication assembly, a first polling signal according to a first power level during the polling sub-period of the first time period; and
in a second time period of the sequence: transmitting, from the short-range wireless communication assembly, a second polling signal according to a second power level during the polling sub-period of the second time period.

12. The computing device of claim 11, wherein each of the time periods in the sequence further includes a listening sub-period following the polling sub-period; the processor further configured to:
monitor for a first response to the first polling signal during the listening sub-period of the first time period, and
monitor for a second response to the second polling signal during the listening sub-period of the second time period.

13. The computing device of claim 11, wherein each of the time periods in the sequence further includes an emulation sub-period; the processor further configured to:
monitor for a first external polling signal in the emulation sub-period of the first time period; and
monitor for a second external polling signal in the emulation sub-period of the second time period.

14. The computing device of claim 11, wherein one of the first power level and the second power level is smaller than the other of the first power level and the second power level.

15. The computing device of claim 11, further comprising:
a display;
wherein the antenna is disposed to transmit the first and second polling signals through the display.

16. The computing device of claim 15, wherein the one of the first power level and the second power level is selected to mitigate visual artifacts at the display during transmission of at least one of the first polling signal or the second polling signal.

17. The computing device of claim 11, wherein the first time period and the second time period of the sequence have equal lengths.

18. The computing device of claim 11, wherein the processor is further configured, during a third time period of the sequence, to:
transmit, from the short-range wireless communication assembly, a third polling signal according to one of the first power level and the second power level, during the polling sub-period of the third time period.

19. The computing device of claim 11, wherein the processor is further configured, prior to controlling the short-range wireless communication assembly, to:
obtain configuration data including the first power level and the second power level.

20. The computing device of claim 19, wherein the configuration data further includes:
the sequence of time periods, and
for each of the time periods, an association between the time period and one of the first power level and the second power level.

21. The computing device of claim 11, wherein the short-range wireless communication assembly is a near-field communication (NFC) assembly.
